(19) United States
(12) Patent Application Publication
(10) Pub. No.: US 2009/0156046 A1
(43) Pub. Date: Jun. 18, 2009

(54) Connector assembly with improved latch

(75) Inventors: Yong-Jun Chen, ShenZhen (CN); Xian-Kui Shi, ShenZhen (CN); Chung-Yen Yang, Tu-cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 12/316,408

(22) Filed: Dec. 12, 2008

(30) Foreign Application Priority Data
Dec. 12, 2007 (CN) 200720131413.9

(51) Int. Cl. H01R 13/625

(52) U.S. Cl. 439/345

(57) ABSTRACT

An electrical connector includes a board connector (3) and a cable connector (2) adapted for mating with the board connector. The board connector defines top and bottom surfaces (32, 31), the bottom surface mounted on a PCB, the top surface forming integrally a locking projection (33) with a stopping surface (331) therein. The cable connector has a base (21), a mating tongue (22) extending forwards from the base and adapted for being received in said board connector, and a latch (23) formed on top surface of the base and extending forwards over the mating tongue. The latch is rotatable to lock or unlock with the locking projection of the board connector, and has a stopping surface (231) for abutting against said stopping surface of the locking projection to prevent the latch from withdrawing after locking with the locking projection. The stopping surface of the latch forms a bump (2311), and the stopping surface of the locking projection forms a recess (3311) to receive said bump.

### BACKGROUND OF THE INVENTION

1. Field of the Invention

This invention generally relates to a connector assembly, and more particularly, to a connector assembly with an improved latch.

2. Description of the Prior Art

U.S. Pat. No. 5,342,221 issued to Peterson on Aug. 30, 1994 discloses a connector assembly with a latch structure to hold the connector assembly. However, the latch is not stable enough is some applications.

Hence, an improved connector assembly is desired to overcome the above problem.

### BRIEF SUMMARY OF THE INVENTION

It is an object of the present invention to provide an electrical connector having an improved latch.

In order to attain the object above, a connector assembly according to the present invention comprises a board connector and a cable connector adapted for mating with the board connector. The board connector defines top and bottom surfaces, the bottom surface mounted on a PCB, the top surface forming integrally a locking projection with a stopping surface therein. The cable connector has a base, a mating tongue extending forwards from the base and adapted for being received in said board connector, and a latch formed on top surface of the base and extending forwards over the mating tongue. The latch is rotatable to lock or unlock with the locking projection of the board connector, and has a stopping surface for abutting against said stopping surface of the locking projection to prevent the latch from withdrawing after locking with the locking projection. The stopping surface of the latch forms a bump, and the stopping surface of the locking projection forms a recess to receive said bump.

Other objects, advantages and novel features of the invention will become more apparent from the following detailed description of the present embodiment when taken in conjunction with the accompanying drawings.

### BRIEF DESCRIPTION OF THE DRAWINGS

The features of this invention which are believed to be novel are set forth with particularity in the appended claims. The invention, together with its objects and the advantages thereof, may be best understood by reference to the following description taken in conjunction with the accompanying drawings, in which like reference numerals identify like elements in the figures and in which:

FIG. 1 is a perspective view of an insulator of a cable connector in accordance with the present invention;

FIG. 2 is a side view of the insulator shown in FIG. 1;

FIG. 3 is a cross-section view showing mating process of the cable connector and a board connector;

FIG. 4 is a cross-section view showing the cable connector and the board connector which have been mated with each other.

### DETAILED DESCRIPTION OF THE INVENTION

Reference will now be made in detail to the preferred embodiment of the present invention.

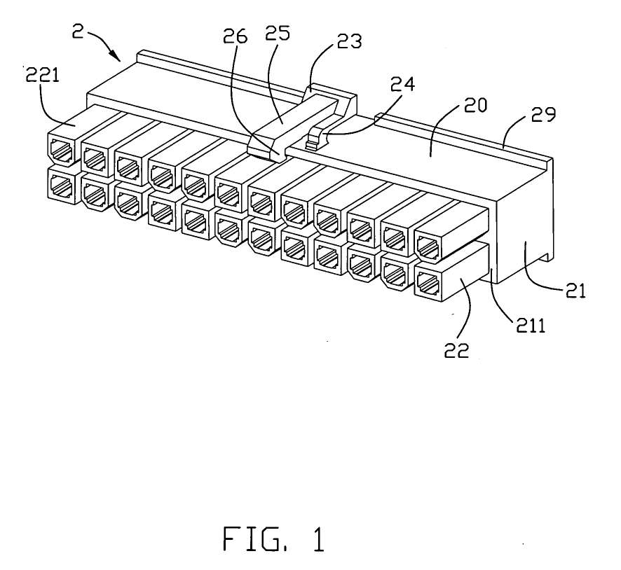

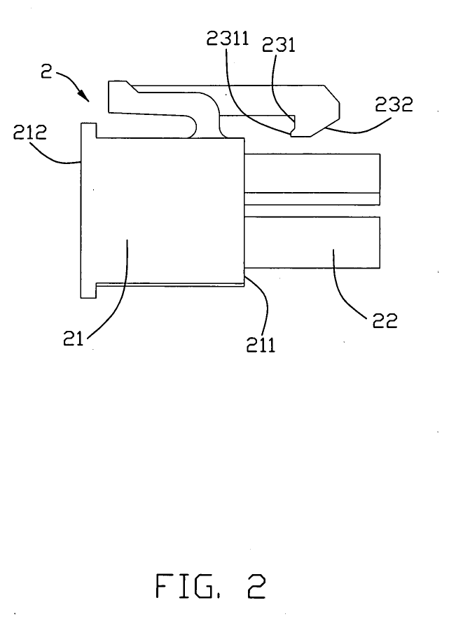

Please referring to FIGS. 1-4, an electrical connector assembly according to the present invention has a cable connector 2 and a board connector 3 engaging with each other. The board connector 3 has a bottom surface 31 mounted onto a PCB (not shown) and a top surface 32 with a locking projection 33.

The cable connector 2 has an insulator 20 with a plurality of conductive terminals (not shown) therein. The insulator 20 comprises a base 21 and a mating tongue 22 extending forwards from the base 21 in order to receive in the board connector 3. The base 21 defines front and rear surface 211, 212, and a plurality of terminal grooves (not shown). The mating tongue 22 is composed of a plurality of terminal tubes 221 extending forwards from the front surface 211 of the base 21 and spaced from each other. The terminal tubes 221 communicate with the corresponding terminal grooves, and cooperate with the terminal grooves to form a plurality of terminal rooms for accommodating the conductive terminals. A pair of ribs 29 protrude from top and bottom surfaces of the base 21 to facilitate an operator to hold.

A latch 23 is formed integrally with the top surface of the base 21, and engages with the locking projection 33 of the board connector 3 to keep the connection between the cable connector 2 and the board connector 3. The latch 23 comprises a root 24 connecting with the top surface of the base 21, a lever 25 extending along front-and-rear direction from top end of the root 24 and adapted to rotate about the root 24, and a hook 26 in front of the lever 25 above the mating tongue 22.

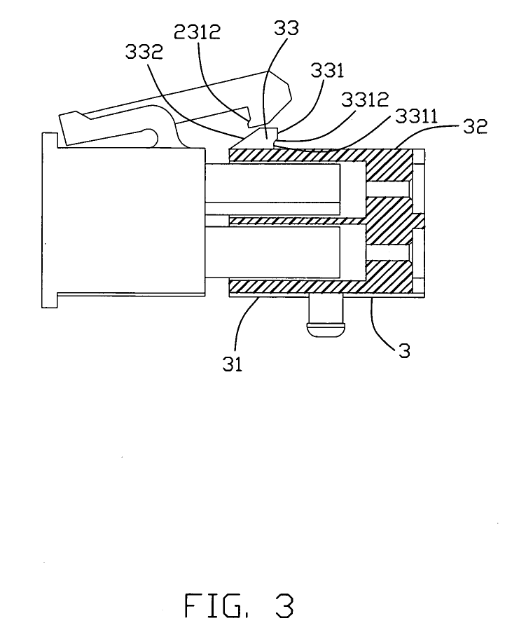

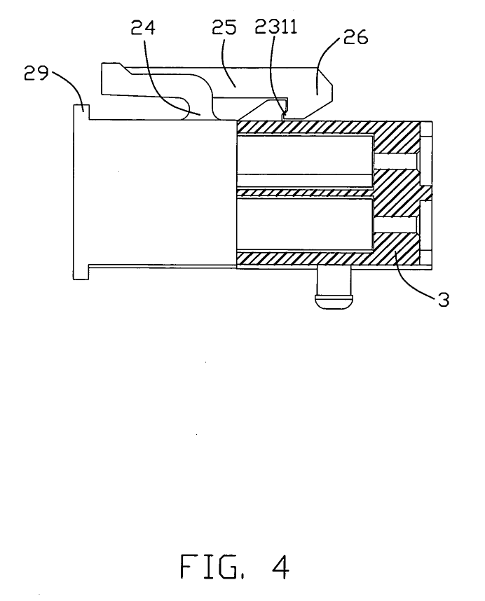

The hook 26 and locking projection 33 have stopping surfaces 231, 331 at their rear ends and inclined surfaces 232, 332 at their front ends. Please referring to FIGS. 3-4, in mating process, the inclined surfaces 232, 332 lead the hook 26 of the latch 23 over the stopping surface 331 of the locking projection 33, then the inclined surface 231 of the hook 26 abuts against the inclined surface 331 of the locking projection 33 to hold them together. The stopping surface 231 of the latch 23 forms a bump 2311, and the stopping surface 331 of the locking projection 33 forms a recess 3311 to receive the bump 2311 in order to enhance the connection between the stopping surfaces 231, 331. The bump 2311 has an inclined plane 2312 connecting with the stopping surface 231, and the recess 3311 has an inclined plane 3312 to connect with the stopping surface 331. Furthermore, the bump 2311 is formed at free end of the hook 26 so that it is easy for the bump 2311 to enter into the recess 3311.

It is to be understood, however, that even though numerous, characteristics and advantages of the present invention have been set fourth in the foregoing description, together with details of the structure and function of the invention, the disclosed is illustrative only, and changes may be made in detail, especially in matters of number, shape, size, and arrangement of parts within the principles of the invention to the full extent indicated by the broad general meaning of the terms in which the appended claims are expressed.

What is claimed is:

1. A connector assembly, comprising:
a board connector having top and bottom surfaces, the bottom surface mounted on a PCB, the top surface forming integrally a locking projection with a stopping surface therein;
a cable connector adapted for mating with said board connector, said cable connector having a base, a mating tongue extending forwards from the base and adapted for being received in said board connector, and a latch formed on top surface of the base and extending forwards over the mating tongue;
wherein the latch is rotatable to lock or unlock with the locking projection of the board connector, and has a stopping surface for abutting against said stopping surface of the locking projection to prevent the latch from withdrawing after locking with the locking projection;
wherein the stopping surface of the latch forms a bump, and the stopping surface of the locking projection forms a recess to receive said bump.

2. The connector assembly as recited in claim 1, wherein the bump is formed at free end of the stopping surface of the latch.

3. The connector assembly as recited in claim 1, wherein the latch and the locking projection each have an inclined surface at their front ends to lead the latch over the locking projection.

4. The connector assembly as recited in claim 1, wherein the mating tongue is formed integrally with the base.

5. The connector assembly as recited in claim 1, wherein an inclined plane is formed to connect the bump and the stopping surface of the latch, and another inclined plane is formed to connect the recess and the stopping surface of the locking projection.

6. The connector assembly as recited in claim 1, wherein the mating tongue is composed of a plurality of terminal tubes extending forwards from the base and spaced from each other.

7. An electrical connector, comprising:
a base defining front and rear surfaces facing to each other, and a plurality of terminal grooves through the front and rear surfaces;
a mating tongue formed integrally with the base and having a plurality of terminal tubes extending forwards from the base, the plurality of terminal tubes spaced from each other and communicating with the terminal grooves in order to receive the conductive terminals therein;
a latch formed integrally with an outer surface of the base, and comprising a root connecting with the base, a lever extending along a front-and-rear direction from top end of the root and adapted to rotate about the root, and a hook in front of the lever above the mating tongue;
wherein the hook comprises an inclined surface at the front and a stopping surface with a bump thereof at the rear.

8. The electrical connector as recited in claim 7, wherein said bump is formed at free end of the stopping surface.

9. The electrical connector as recited in claim 7, wherein the lever is parallel to said outer surface in its original state.

10. The electrical connector as recited in claim 7, wherein a rib protrudes from said outer surface of the base to facilitate an operator to hold.

11. An electrical connector assembly comprising:
first and second connectors head to head locking to each other;
said first connector defining a first insulative housing unitarily formed with thereon a deflectable latch extending in a cantilevered manner to be adapted to be upwardly deflected at a front end, said latch including a hook structure at said front end thereof, said hook structure including a front downward inclined surface facing forward and a rear upward inclined surface facing rearward, said front downward inclined surface and said rear upward inclined surface both located adjacent to a locking tip area of the hook structure, and
said second connector defining a second insulative housing unitarily formed with a locking projection, said locking projection including a front upward inclined face for engagement with the front downward inclined surface of the hook structure at an initial locking stage, and a rearward downward inclined face for engagement with the rear upward inclined face of the hook structure at a final locking stage.

12. The electrical connector assembly as claimed in claim 11, wherein said front downward inclined surface of the hook structure is larger than the rear upward inclined surface of the hook structure.

13. The electrical connector assembly as claimed in claim 11, wherein the front upward inclined face of the locking projection is larger than the rearward downward inclined face.

14. The electrical connector assembly as claimed in claim 11, wherein the hook structure further defines two vertical rearward surfaces respectively located by upper and lower sides of said the rear upward inclined surface of the hook structure.

15. The electrical connector assembly as claimed in claim 14, wherein the locking projection further defines two vertical rearward faces respectively located by upper and lower sides of the rear downward inclined face of the locking projection for respective engagement with said two vertical rearward faces of the hook structure.

16. The electrical connector assembly as claimed in claim 11, wherein the locking tip area of the hook structure is essentially intimately facing an exterior face of the second connector.

17. The electrical connector assembly as claimed in claim 16, wherein the locking projection defines a horizontal face located between the front upward inclined face and the rearward downward inclined face, and intimately facing the latch and away from the exterior face of the second connector.
